(19) United States
(12) Patent Application Publication
(10) Pub. No.: US 2007/0059464 A1
(43) Pub. Date: Mar. 15, 2007

(54) Controlled peel force packaging with pattern-applied energy-cured coating

(75) Inventor: Scott W. Huffer, Hartsville, SC (US)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Sonoco Development Inc., a corporation of South Carolina, Hartsville, SC (US)

(21) Appl. No.: 11/227,530

(22) Filed: Sep. 15, 2005

(51) Int. Cl. B32B 27/32; B32B 7/06

(52) U.S. Cl. 428/35.2; 428/194; 428/200; 428/201

(57) ABSTRACT

The present invention relates to a flexible package that includes a packaging material having a sealant web with a first side and a second side. Disposed on the first side of the sealant web is a pattern of an energy-cured coating. The package also includes a heat sealed area, at least a portion of the pattern of energy-cured coating being disposed within the heat sealed area. A method for creating the flexible package is also described.

### TECHNICAL FIELD

The present invention relates to the field of flexible packaging. Particularly, the invention relates to flexible packaging having controllable peel force characteristics and a method for making such flexible packaging.

### BACKGROUND OF THE INVENTION

Polymeric sealant films are conventionally used as packaging for a wide variety of products, including food products. Such packages often include a heat seal formed from heat activated polymers present on the surface of opposing packaging materials or on the surface of opposing sections of the same packaging material. In order to control the coefficient of friction of the film to meet processing needs, slip agents are often added to the heat seal layer.

Slip agents are generally migratory waxes added to the resin before extruding or blowing the film. Examples of such waxes include behenamide, stearamide, and erucamide. Migratory slip agents are selected for their incompatibility with the resin in which they are dispersed. Due to this incompatibility, the slip agents migrate to the surface of the structure, where they form a thin film. This process is known as blooming.

These migratory additives have disadvantages when used in packaging. First, the additive may not uniformly migrate to the surface of the packaging material. Nonuniform migration can result in nonuniform peel strength and uneven peel forces along the heat seal, which can lead to tears or holes in the packaging material. The resulting tears or holes can allow contamination or leakage of product from the package.

Another disadvantage is that migratory additives can create an unpredictable coefficient of friction. The concentration of slip agents that have bloomed to the surface lower the coefficient of friction of the packaging material. However, the coefficient of friction is unpredictable, with variations based on the amount of the slip agent that actually migrates to the surface. When the sealant web has an unpredictable coefficient of friction, the packaging material may not run properly on filling equipment. For example, portions of the packaging material with higher coefficients of friction may stick to the manufacturing equipment, causing the equipment to jam or otherwise function improperly. The result is wasted packaging material and time during the manufacturing process.

In addition, if the packaging material is stored in a roll, the migratory slip agents could offset onto the outer side of the packaging material, thereby lessening the aesthetic quality of the packaging material.

### SUMMARY OF THE INVENTION

One embodiment of the present invention is a flexible package that includes at least one sheet of a packaging material having a sealant web with a first side and a second side. Disposed on at least a portion of the first side of the sealant web is a pattern-applied energy-cured coating. The coating is cured with a suitable energy source. The package also includes a heat sealed area, which includes at least a portion of the pattern-applied energy-cured coating. The package has a peel force controlled by the amount of energy-cured coating applied and by the pattern in which it is applied.

Another embodiment of the present invention is a flexible package that includes at least one sheet of a packaging material having a sealant web with a first side and a second side. Disposed on the second side of the sealant web is a printing web. Disposed on at least a portion of the first side of the sealant web is a pattern-applied energy-cured coating. The package also includes a heat sealed area, which includes at least a portion of the pattern-applied energy-cured coating.

A further embodiment of the present invention is a method of making a package. The method includes providing a sheet of packaging material having a sealant web, the sealant web having a first side and a second side. The method further includes pattern applying an energy curable coating on at least a portion of the first side of the sealant web. The coating is then cured with a suitable energy source. The sheet of packaging material is formed into the package by sealing a sealing area, the sealing area having at least a portion of the pattern-applied energy-cured coating. The method can further include applying an impermeable layer and/or printing web onto the sealant web.

### BRIEF DESCRIPTION OF THE DRAWINGS

For the purpose of illustrating the invention, there is shown in the drawings various forms which are presently preferred; it being understood, however, that this invention is not limited to the precise arrangements and instrumentalities particularly shown.

FIG. 1 is a packaging material of the present invention.

FIG. 2 is a cross section of a packaging material of the present invention that includes a printing web.

FIG. 3 is a cross section of a packaging material of the present invention that includes a printing web and an additional layer.

FIG. 4 is a package manufactured from packaging material of the present invention.

### DETAILED DESCRIPTION OF THE INVENTION

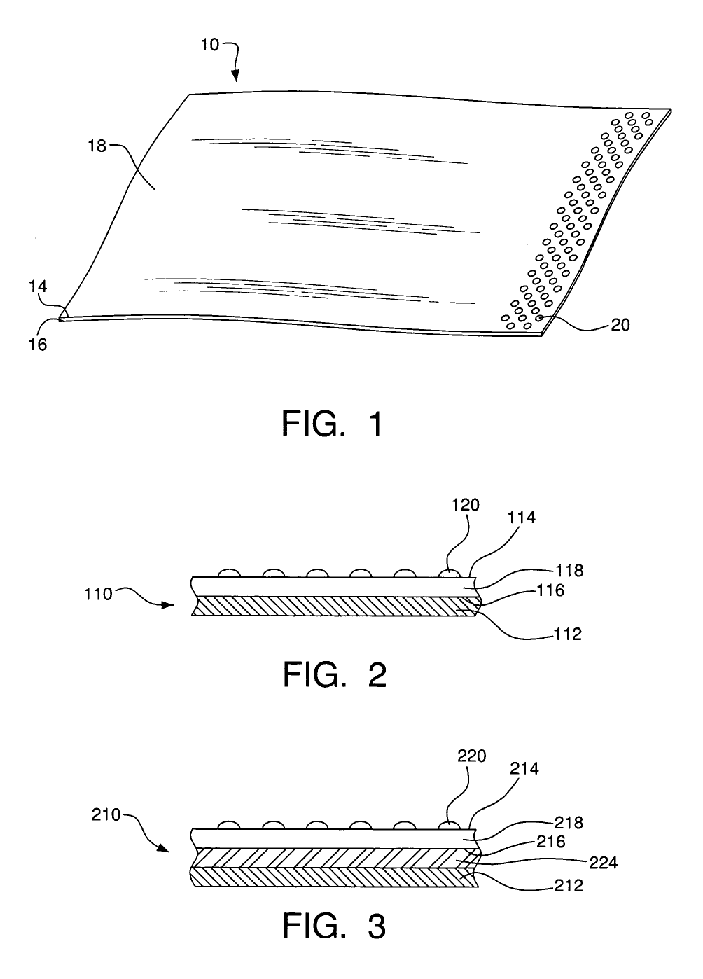

In the drawings, where like numerals identify like elements, there is shown in FIG. 1 a sheet of flexible packaging material, which is generally designated by the numeral 10. As used herein, the term “flexible packaging material” includes materials used in the manufacture of flexible packages (e.g., candy wrappers) and materials used in covering and/or sealing rigid or semi-rigid containers (e.g., microwavable dinner containers). These will sometimes be referred to as packaging films, or simply as films.

As shown in FIG. 1, the material 10 includes a heat sealant web 18, sometimes referred to simply as the sealant web, having a first side 14 and a second side 16. A pattern of an energy-curable coating 20 is pattern-applied on at least a portion of the first side 14 of the sealant web 18. If desired, the energy-curable coating can be pattern-applied to the entire first side 14 of the heat sealant web 18. As used herein and described in more detail below, the term “pattern-applied” means that the EB curable coating is applied to the heat sealant web in a pattern that leaves voids in the coating so as to leave exposed (i.e., uncoated) portions of the sealant web 18. Thus, what is meant by pattern applying the energy-curable coating to the “entire surface” is that a pattern is applied over the entire film, with voids associated with exposed heat sealant web throughout the pattern. The portions of exposed heat sealant web are preferably interconnected, but can instead be isolated from one another by the pattern-applied coating. Once applied, the energy-cured coating is energy-cured with a suitable energy.

The sealant web 18 is selected from the group consisting of polyethylene, low density polyethylene (LDPE), and linear low density polyethylene (LLDPE). Alternatively, the sealant web 18 is selected from the group consisting of polypropylene, oriented polypropylene (OPP), and cast polypropylene (CPP). In a further alternative, the sealant web 18 is a metallocene catalyzed polymer. Metallocene catalysts have high thermal stability (up to and over 500° C.). Metallocenes are generally soluble in common organic solvents and can be purified by vacuum sublimation. Ferrocene is a preferred metallocene. Ferrocene is favorable in that it is not sensitive to air, is not paramagnetic, and it possesses a closed-shell electron structure.

In addition to the above mentioned materials, the sealant web 18 can be any material with a low seal initiation temperature (“SIT”), e.g. low SIT resins. A low SIT is generally important in flexible packaging because it allows for high packaging line speeds by reducing the time and energy necessary to form the heat seal. A low SIT is particularly important in the context of the present invention because the sealant web is exposed to energy used to cure the pattern-applied energy-cured coating. When the sealant web is exposed to the energy, the material of the sealant web may partially cross link, resulting in a higher SIT. Because the SIT can be increased as a result of practicing the invention, a low starting SIT is critical for maintaining low SIT after exposure to the curing energy and thus is critical for maintaining high packaging line speeds.

Preferably, the sealant web 18 is a “barefoot sealant”, which, as used herein, is a sealant material that lacks both slip additives and anti-block additives. More preferably, the sealant web is a barefoot polyethylene (including LDPE, LLDPE or a metallocene catalyzed PE) or a barefoot OPP. The lack of slip additives and anti-block additives aids in maintaining a low SIT even after being exposed to the energy curing by limiting the materials that can be cross-linked.

On top of the sealant web 18, a pattern of an energy-cured coating 20 is applied. The coating 20 can be applied using conventional printing techniques, such as rotogravure or flexographic. Flexographic and rotogravure printing are well known in the art and, in the interest of conciseness, will not be described here.

As illustrated, the energy-cured coating is in a pattern of uniform dots. However, the invention is not so limited. The coating can be applied in a uniform or a non-uniform pattern. The coating can be applied as a pattern of dots, triangles, squares, ovals, horizontal stripes, vertical stripes, diagonal stripes, and other geometric and non-geometric shapes of varying sizes. The coating can also be a combination of different patterns.

The energy-cured coating has suitable slip characteristics to provide the film with appropriate processing qualities. Slip characteristics can be mechanical in nature, meaning that the pattern-applied energy-cured coating can provide raised points that limit the surface area in contact with processing equipment to reduce friction. The energy-cured coating can also have chemical slip characteristics. In this respect, non-migratory slip agents can be added to the energy-cured coating, as described below.

The amount of area the energy-cured coating covers effects the coefficient of friction of the sealant web. Where chemical slip characteristics are employed, the larger the area covered by the coating, the lower the coefficient of friction of the packaging material surface. Control of the coefficient of friction is particularly advantageous when the packaging material is formed into a package. By modifying the amount/pattern of the energy-cured coating applied to the sealant web with this invention, slip characteristics can be finely tuned to ensure that the film can be run on any particular production equipment.

In addition, the amount of area the energy-cured coating covers effects the strength of the heat seal. As explained below, the energy-cured coating becomes substantially cross-linked during the curing step. The cross-linked coating can have a high melting temperature. Thus, the energy-cured coating can be produced so as not to form heat seals under ordinary heat sealing conditions. Because the pattern-applied energy-cured coating does not participate significantly in heat sealing, it acts by masking portions of the heat seal, which would otherwise be formed between the low SIT sealant web and the surface with which it is in contact (such as itself, a second heat sealant web, the opposite face of the packaging material, etc.). By increasing the portion of the seal area over which the energy-cured coating is applied, the peel force necessary to open the seal can be reduced as desired. As such, packages can be made with a peel force that would allow an end user to open the package by simply pulling the packaging material apart, or alternatively with a peel force such that scissors are necessary to open the package or with a peel force somewhere in between.

The coating pattern can be applied over the entire sealant web 18, or, as illustrated in FIG. 1, only over a portion of the sealant web 18. Applying the coating pattern over the entire sealant web allows for processing of the same packaging material for a variety of different sized packages. If the coating pattern is applied to only a portion of the sealant web, the packaging material must be registered to ensure that the coating is present in the area to be sealed, which adds time and sophistication to the manufacturing process.

The energy-cured coating 20 can comprise a number of species of suitable compounds. For food packaging, the coating should be food-grade, especially if the coating is pattern-applied to the entire sealant web. Preferably, the coating 20 is made up of 100% solids, which include a combination of oligomers and monomers. The preferred oligomer is an epoxy acrylate. The preferred monomer is acrylate. The monomers act as diluents that reduce the viscosity of the coating for purposes of application. The concentration of monomers can be adjusted to provide a wide range of viscosity, such that many coating systems can be employed to apply the energy-curable coating 20. The oligomers and monomers form a stable network when cured with a suitable energy.

The energy-cured coating 20 is cured using a suitable energy source such as electron beam (“EB”) radiation or ultraviolet (“UV”) radiation. EB radiation is preferred over UV radiation because EB radiation does not require photoinitiators, which are generally migratory in nature. For EB radiation, suitable electron beam sources can be obtained commercially from Energy Science, Inc. of Wilmington, Mass. The electron energy output should be within the range of 110 kV to 135 kV at a dosage of 2.5 to 5.0 megarads. Preferably, the energy is within the range of 125 kV to 135 kV at a dosage of 3.0 to 4.0 megarads.

In one embodiment, when exposed to an energy from a suitable source, acrylate monomers react into the epoxy acrylate chain to form cross-links. When EB radiation is used, the cross-linking requires no initiator compounds. Therefore no residual volatile organic compounds are present in the finished product.

With EB and UV radiation, curing generally provides a cure percentage at or near one hundred percent after only a brief exposure (i.e., less than a few seconds) to the energy. Thus, the curing is considered substantially instantaneous.

The energy dose is generally applied to the flexible packaging material as a whole. However, where the coating is applied to only a portion of the packaging material, it may be desirable, if cost effective, to apply the energy dose to only that portion of the packaging material.

Various desirable additives, the exact nature of which will depend on the specifications of the packaging material 10, can be added to the energy-cured coating 20. Additives, such as slip, anti-block, leveling, and defoaming agents, can be provided to improve qualities such as the coefficient of friction (discussed above) and other processing qualities. Additives included in the energy-cured coating 20 can react into the oligomer/monomer network, thereby becoming non-migratory, meaning fixed or “reacted-in”, during energy curing of the coating. Reacting-in occurs when carbon-carbon double bonds of the additive and the coating are broken, resulting-in the linking and polymerizing of the additive with the energy-cured coating.

Slip agents, which aid in lessening the coefficient of friction in the area where the coating is applied, can be added to the energy curable coating to achieve the slip characteristics discussed above. Suitable slip agents for the energy-cured coating include micronized PE waxes and hydroxy functional silicones. During energy curing, the slip agents react-in to the coating, becoming fixed within the coating. The properties exhibited by the energy-cured coating with a reacted-in slip agent of the present invention would not be expected of a coating having migratory slip agents, such as erucamide. A coating with a reacted-in slip agent overcomes the problems associated with migratory slip agents discussed above.

Thus, the pattern-applied energy-cured coating can provide sufficient slip and anti-blocking properties for film processing. At the same time, by providing the pattern-applied energy-cured coating according to the invention, the film can be provided with sufficient unmasked heat sealant web to form adequate heat seals. Moreover, the peel strength required to separate the seal can be adjusted by increasing or decreasing the masked heat seal area by changing the application pattern and/or amount of energy-cured coating.

As shown in FIG. 2, one embodiment of the sheet of packaging material 110 includes a sealant web 118 having a first side 114 and a second side 116. Disposed on at least a portion of the first side 114 is a pattern of an energy-cured coating 120, the coating being energy-cured with a suitable energy. Disposed on the second side 116 is a printing web 112. The printing web 112 can be combined with the sealant web 118 by adhesive lamination, co-extrusion, extrusion coating, or the like before or after the coating 120 is applied to the sealant web and before or after the coating 120 is energy-cured.

Preferably, the printing web 112 is a polymeric material capable of retaining ink. For example, polyethylene terephthalate and polypropylene are preferred. The printing web 112 allows ink printing of product labels, information and the like onto the packaging material. The ink can be applied using standard printing techniques, such as rotogravure or flexographic printing.

As shown in FIG. 3, one embodiment of the sheet of packaging material 210 includes a sealant web 218 having a first side and a second side. A pattern of an energy-cured coating 220 is disposed on at least a portion of the first side of the sealant web 218, the energy-cured coating 220 being energy-cured with a suitable energy. An additional layer 224 is disposed on the second side 216. Opposite the sealant web 218, a printing web 212 is disposed on the additional layer 224. The additional layer 224 and the printing web 212 can be disposed onto the adjacent material via lamination, co-extrusion, extrusion coating or the like.

Inclusion of the additional layer 224 is preferred where a specific property of the packaging material is desired but cannot be achieved simply from the combination of the sealant web and printing web or other flexible substrate. For example, an additional layer 224 such as a foil layer or other impermeable layer can be included in the packaging material where low oxygen transmission and/or water transmission rates are desired.

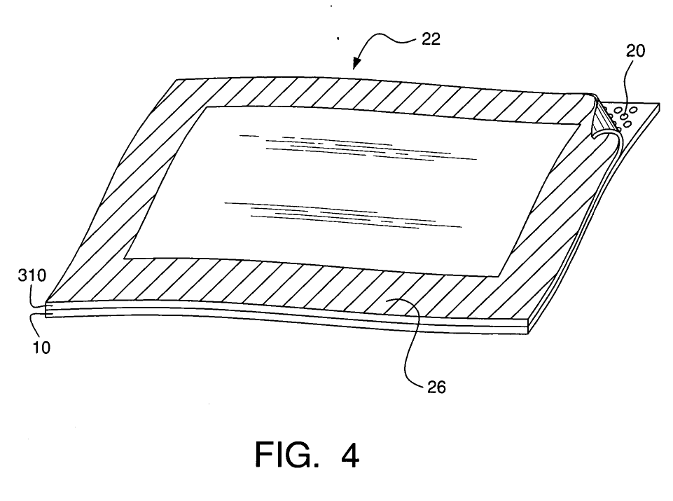

As shown in FIG. 4, the flexible packaging material 10 (packaging materials 110 or 210 could also be used) and a second flexible packaging material 310 are made into a package 22 having a pattern of an energy-cured coating 20 on at least one of the packaging materials 10, 310. The packaging material 310 can be the same as packaging material 10, 110 or 210, or can have a conventional heat sealant web without a pattern-applied energy-cured coating. The package 22 has a heat sealed area 26 that encloses and seals the contents of the package 22. The heat sealed area 26 includes at least a portion of the energy-cured coating 20. Where the packaging material 310 is the same as packaging material 10, the package 22 can be produced by folding the material against itself and heat sealing the three open sides. Other possible package configurations are discussed below.

Because the energy-cured coating is applied in a pattern, the coating masks portions of the sealant web. The masking provides improved and controllable release properties by adjusting the contact surface between the coated heat sealant web and the opposing film, thereby interrupting the heat seal in the masked portions and allowing for greater ease in opening the package. Less surface to surface contact between the heat sealant web and the opposing film provides less surface to surface sealing area, which, in turn, results in improved release properties.

Because the energy-cured coating preferably includes a reacted-in slip agent, the coated area has chemical slip properties. The chemical slip properties, together with mechanical slip provided by the uneven surface, improve the coefficient of friction of the film to assist in processing, thereby eliminating the need for problematic migratory slip agents in the heat sealant web. Moreover, the combination of the mechanical slip properties and the chemical slip properties provides for greater control of the coefficient of friction in the area of the pattern-applied energy-cured coating. At the same time, the masking effect of the pattern-applied coating provides greater control of the peel force required to open the seal area once the packaging material is in package form.

The improved control over the coefficient of friction and peel force is not limited to the packaging illustrated in FIG. 4. Rather, alternative packaging arrangements are also within the scope of the invention. For example, the package may include only a single sheet of packaging material and be configured so as to include a lap seal or a fin seal. A lap seal is formed, for example, when the packaging material is slit to an appropriate width, formed into a tubular structure with opposed edges overlapped and sealed at least a portion of the sealed area having the energy-cured coating. Thus, the inside surface of one edge is sealed to the outside surface of the opposed edge with the seal extending substantially parallel with the adjacent portion of the tubular structure. A fin seal, on the other hand, is formed when the inside surface of each opposed edge of the tubular structure are brought into contact with one another and sealed. Such a seal can extend in a direction independent of the adjacent portion of the tubular structure, and absent folding or other influence, tends to extend perpendicular thereto.

The sheet of flexible packaging material can also be formed into a pillow pouch. The material is again formed into a tubular structure. The top of the tubular structure and the bottom of the tubular structure are collapsed between sealing jaws to form a top end seal and a bottom end seal, respectively. The pillow pouch also includes a longitudinal lap seal, which is formed as described above.

The pillow pouch can be formed, filled and sealed on a vertical or horizontal form-fill-seal machine. When the pouch is formed on a vertical form-fill-seal machine, the packaging material is first slit to the appropriate width. The sheet of packaging material is then fed to the vertical form-filled machine, which forms the tubular structure, the bottom end seal and longitudinal lap seal. The pouch is filled with a product prior to forming the top end seal.

It will be appreciated by those skilled in the art, that the present invention may be practiced in various alternative forms and configurations. The previously detailed description of the disclosed embodiments is presented for purposes of clarity of understanding only, and no unnecessary limitations should be implied there from.

I claim:

1. A flexible package comprising:
a film comprising
a heat sealant web comprising a first side and a second side, and
an energy-cured coating pattern applied to at least a portion of the first side of the heat sealant web;
the package having at least one heat sealed area formed with a portion of the first side of the heat sealant web sealed to a surface selected from the group consisting of a second portion of the first side of the heat sealant web, the second side of the heat sealant web, a second web attached to the second side of the heat sealant web and a second film;
the pattern-applied energy-cured coating masking a portion of the first side of the heat sealant web in the heat sealed area, thereby interrupting the heat seal in the masked portion.

2. A flexible package according to claim 1, wherein the heat sealant web is a barefoot sealant.

3. A flexible package according to claim 2, wherein the heat sealant web is selected from the group consisting of polyethylene, low density polyethylene, and linear low density polyethylene.

4. A flexible package according to claim 2, wherein the heat sealant web is selected from the group consisting of polypropylene, oriented polypropylene, and cast polypropylene.

5. A flexible package according to claim 2, wherein the heat sealant web is metallocene catalyzed.

6. A flexible package according to claim 5, wherein the metallocene is ferrocene.

7. A flexible package according to claim 1, wherein the energy-cured coating comprises a food grade resin.

8. A flexible package according to claim 7, wherein the energy-cured coating consists essentially of solids.

9. A flexible package according to claim 1, wherein the energy-cured coating comprises a reacted-in slip agent.

10. A flexible package according to claim 1, wherein the energy-cured coating is cured with electron beam radiation.

11. A flexible package according to claim 1 further comprising an impermeable layer disposed on the second side of the sealant web and a printing web disposed on the impermeable layer opposite the sealant web.

12. A flexible package according to claim 11, wherein the impermeable layer comprises foil.

13. A flexible package according to claim 11 wherein the printing web is selected from the group consisting of polypropylene and polyethylene terephthalate.

14. A flexible package according to claim 1 consisting of only one film.

15. A package comprising:
at least one sheet of a flexible packaging material comprising
a heat sealant web having a first side and a second side;
a printing web disposed on the second side of the sealant web; and
a pattern of an energy-cured coating disposed on at least a portion of the first side of the sealant web;
at least one heat sealed area formed with a portion of the first side of the heat sealant web sealed to a second portion of the first side of the heat sealant web, at least a portion of the pattern of energy-cured coating being disposed within the heat sealed area.

16. A package comprising:
at least one sheet of a flexible packaging material comprising
a heat sealant web having a first side and a second side, the sealant web comprising barefoot polyethylene; and
a pattern of an electron beam-cured resin disposed on the first side of the sealant web;
at least one heat sealed area formed with a portion of the first side of the heat sealant web sealed to a second portion of the first side of the heat sealant web, at least a portion of the pattern of electron beam-cured resin being disposed within the heat sealed area.

17. A method of making a flexible package comprising:
providing a flexible substrate, the substrate comprising a first side and a second side;
applying a heat sealant web to at least a portion of the first side of the substrate;
pattern applying an energy curable coating on at least a portion of the sealant web opposite the substrate;
curing the coating with an energy source to form a packaging material with an energy-cured coating;
forming the packaging material into a package such that the surface of the heat sealant web opposite the substrate is in contact with itself or the second side of the substrate in a sealing area, at least a portion of the pattern of energy-cured coating being disposed within the sealing area; and
heat sealing the package in the sealing area.

18. A method according to claim 17 further comprising applying a printing web on the second side of the substrate.

19. A method according to claim 17, wherein the flexible substrate is an impermeable layer.
